(19) United States
(12) Patent Application Publication
(10) Pub. No.: US 2011/0220005 A1
(43) Pub. Date: Sep. 15, 2011

(54) Udafan Mesh Flag

(76) Inventor: James Alexander Comfort, Arlington, VA (US)

(21) Appl. No.: 13/038,865

(22) Filed: Mar. 2, 2011

Related U.S. Application Data
(60) Provisional application No. 61/313,780, filed on Mar. 14, 2010.

(51) Int. Cl. G09F 17/00

(52) U.S. Cl. 116/173

(57) ABSTRACT

Embodiments described herein comprise a mesh flag with symbols or colors upon them for the purpose of portraying them. The unique design utilizing a mesh structure enables persons within close proximity of the mesh object to see through it.

The Udafan would be made up of a mesh fabric that is flexible and can have any dimensions for size, as well as any dimensions for the mesh holes. The mesh should be of a size that allows persons at close proximity (as example 0-10 ft) to view at some level of visibility past the flag to more distant objects, places, or things. The type of mesh, the fabric, and the size of the banner are all variables that can be adjusted without deviating from the purpose of the invention. The Front surface of the Udafan would portray a symbol, flag, image, or sign of whatever the user wishes portrayed.

Embodiments of the invention include a flag that is comprised of a mesh structure made with a flexible material through which persons using the flag may see through, containing upon it a visual art that is intended to be displayed by one or more person(s) to other person(s).

### BACKGROUND OF THE INVENTION

Embodiments of the inventive subject matter generally relate to the field of flags, and more particularly to flags that are hand-held for the purpose of displaying a visual message to others.

Flags are often used to portray symbols, colors, objects, etc. . . . to symbolize or represent a message they wish to communicate. As an example their nationality, pride, favorite team, words, motto, slogan, intentions, emotions, feelings, etc. . . . . Flags come in various widths, lengths, and thicknesses. They can be held up on one end with a stick (or pole), usually connected by cord, by two ends as in a demonstration with one side down towards the ground and one side held up towards the sky, or by all the sides in which the direction is irrelevant.

As a movement to support the players, the team, or show ones nationality, pride, favorite team, words, motto, slogan, intentions, emotions, feelings, etc. . . . it has become common practice for fans to create signs, flags, or banners and take them to the event of interest for displaying. Such events can take place within stadiums, arenas, on public property, private property, or any other location where the message can be communicated to others whether physically present or through some form of media (camera, video, live television, drawings, etc. . . . ). Although effective in portraying the intended message, they often are difficult to carry, difficult to display, and often cause the view of the user(s) and those around them to be obstructed in some way. This invention counters those issues in a unique way.

### BRIEF SUMMARY OF THE INVENTION

The Udafan is a mesh flag banner, made up of the unique combination of flexible mesh fabric with a printed design or symbol upon it. Previously a non-mesh flag or banner would cause issues by obstructing the view of persons while in use.

The mesh exists for various uses however has not been applied to banners for the purpose of allowing persons to hold the item and see through it.

The best example of this use is at a game, competition, or other such match where supporting persons wish to show their pride by waving the banner or flag of one of the teams. This often annoys nearby fans and can disrupt the enjoyment for them.

The Udafan would be made up of a mesh fabric that is flexible and can have any dimensions for size, as well as any dimensions for the mesh holes. The Front surface of the Udafan would portray a symbol, flag, image, or sign of whatever the user wishes. Use of the flag would enable those on the field and in front of the Udafan to see the image while those behind the flag (holding or not) would be able to see through the Udafan and see the playing field or whatever they intend to view. The reason this works is that at close proximity the mesh allows the person to see past the fabric while at a distance, the person cannot see the mesh holes and sees the fabric and therefore the design upon it.

As noted earlier, flags and banners are overall an effective method of communicating, however they create new problems altogether in that the flag or banner obstructs the vision of those around it, behind it, or under it.

The Udafan counters this problem because it is a flag or banner of mesh construction which allows for some level of sight to be maintained by those around it, behind it, or under it at close proximity.

Several objects and advantages of the present invention are:
a) To provide a flag that optimally portrays the desired visual message while maintaining some level of visibility for the user(s) and those around them
b) To provide a flag whose construction provides better visibility for the user(s) and those around them than previous inventions assuming equivalent dimensions in length and width.
c) To provide a flag that is enjoyable to use by the user

### BRIEF DESCRIPTION OF THE SEVERAL VIEWS OF THE DRAWING

Where there are drawings, you must include a listing of all figures by number (e.g., FIG. 1A) and with corresponding statements explaining what each figure depicts.

FIG. 1A. Image 1A demonstrates the invention of this application. The object of the image being an example of the Udafan, which is a mesh fabric with a design upon it. The image has been printed or dyed upon the fabric and may also be weaved during the construction to produce the image through designed weaving. This type uses fabric strands of cloth, polyester, or synthetic material that is woven into a mesh.

FIG. 1B. Image 1B represents an example of a design which is used in the example of FIG. 1A, which is a cross with arrows on the ends.

FIG. 1C. This image represents the fabric used in the invention which is a mesh. Any fabric with numerous holes in it, or a fabric made with the structure containing numerous holes.

FIG. 1D. This is a side view of the Udafan.

FIG. 2. The drawing in FIG. 2 identifies a type of woven fabric that can be used for the construction of the mesh, with one set of rows of fabric or strands (Strands A), crossing the strands (B) in the other direction, which together forms a mesh fabric, upon which the design would be printed or dyed. In the case that previously dyed strands are used a weave may create the design seen on either side.

FIG. 3. The drawing from FIG. 3 is an example of a weave in which the material used in the mesh fabric is previously colored whether by dying or in creation of the strands and the design of the weave constitutes the image created and displayed on the mesh fabric.

FIG. 4. The drawing from FIG. 4 is an example of a type of woven mesh fabric upon which the design is printed or dyed. This woven meshes is a single entity created by weaving a semi-permeable structure that allows for anyone at close proximity to have some level of visibility through the entity. This type uses fabric strands of cloth, polyester, or synthetic material that is woven into a mesh. The weave and fabric structure is obtained by weaving the strands from direction A, at an angle to those from direction B.

FIG. 5 The drawing from FIG. 4 is an example of something the user(s) may wish to view, in FIG. 4 being the horizon with a row of trees.

FIG. 6 The drawing from FIG. 5 is an example of the mesh flag which the user wishes to view through, the image being on the opposite side in this case.

FIG. 7. the drawing from FIG. 6 is an example of the mesh flag in use as seen from the perspective of the users, wishing to utilize the mesh flag and view the row of trees simultaneously. This represents the core purpose of the Udafan, a mesh flag that allows the user to show a flag whilst being able to view objects that are beyond the flag in front of them.

### DETAILED DESCRIPTION OF THE INVENTION

As noted earlier, flags and banners are overall an effective method of communicating, however they create new problems altogether in that the flag or banner obstructs the vision of those around it, behind it, or under it.

The Udafan counters this problem because it is a flag or banner of mesh construction which allows for some level of sight to be maintained by those around it, behind it, or under it.

The invention is a flag/banner, made up of the unique combination of flexible mesh fabric with a design or symbol upon it whether by printing or by weaving different colored fabrics to create an image.

I reference two separate items below which will support the issues and solutions for which this application is created:

In Puerto Rico there is a type of advertising which uses a large mesh fabric, hung from the side of buildings. The fabric allows those within the building to still have some view, while allowing for large billboard-like advertising on the side of the building.

The next example is a flag that is sometimes used at football games at the University of Nebraska. The flag is an enormous message that is being portrayed to the other fans, the team, and more than likely media that show the image anywhere else in the world. The issue here is obvious; the fans using the flag cannot see the game in progress. This clearly represents the problem the invention will counter.

The Udafan would be made up of a mesh fabric that is flexible and can have any dimensions for size, as well as any variety of dimensions for the mesh holes. The invention is a flag/ banner, made up of the unique combination of flexible mesh fabric with a design or symbol upon it whether by printing or by weaving different colored fabrics to create an image.

The mesh fabric and technology to produce it currently exists. The banner of woven mesh can be created using either of two processes.

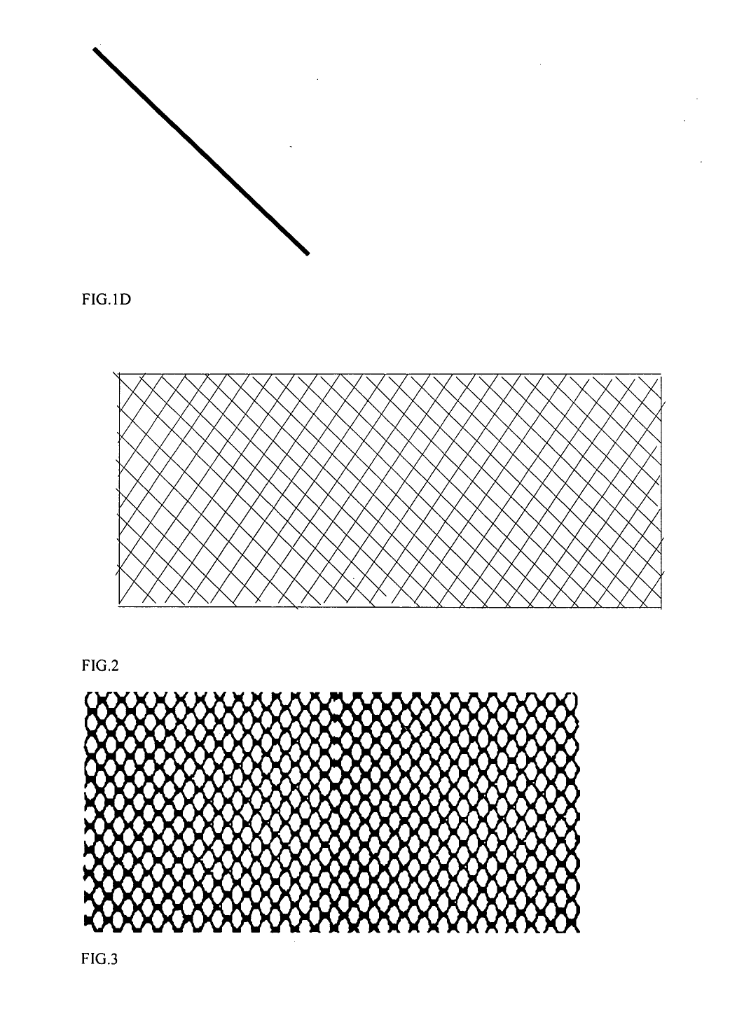

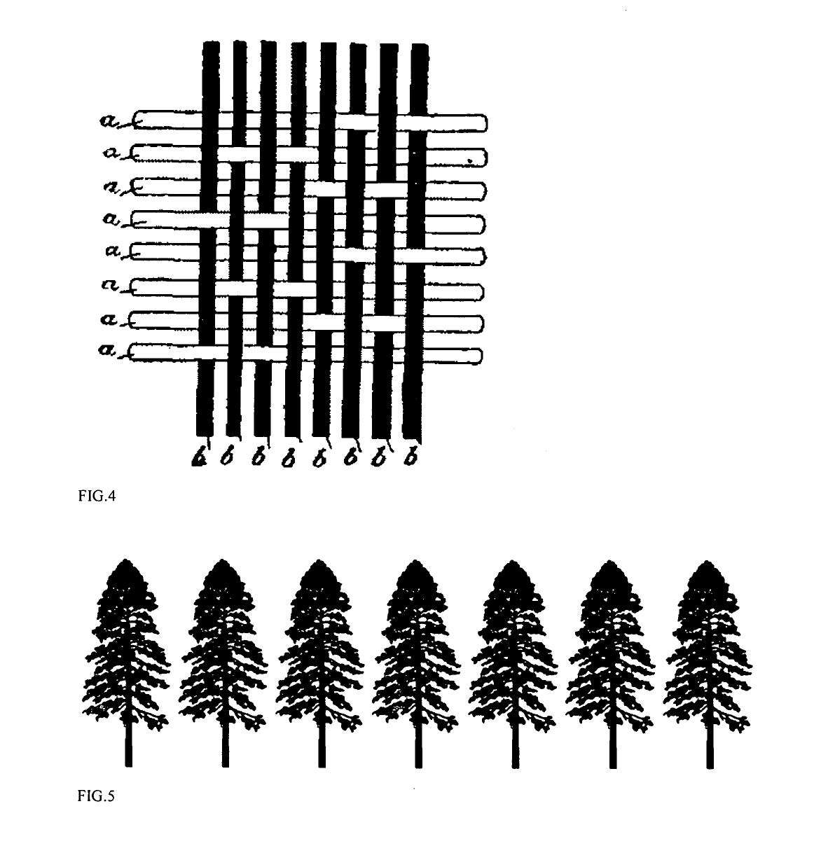

1. Using material that has a distinct color to weave a design within the mesh exemplified by FIG. 2 which identifies a variable method for producing the mesh in which the strips of fabric can be weaved creating a diamond pattern in the holes through which the users view. FIG. 4 provides a close up view of an example of this kind of weave, rotated 45° . The strips of fabric in this case are pre-colored and therefore provides the maker the opportunity to create the image on the mesh by how they fabric is weaved. Within FIG. 4 the vertical strips of fabric, labeled ‘b’ are black, while the horizontal strips of fabric are labeled ‘a’. Through weaving the strips labeled ‘b’ over top the white ones for 3 horizontal strips, while the horizontal strips are only layed over every other one, the fabric is primarily colored black. The exchange can be altered throughout the fabric, thus creating a pattern or design in the mesh fabric.

2. The second method printing or dying the design upon the mesh banner after the mesh has been constructed. The act of printing upon mesh also exists in various forms. The fabric can be dyed or can have a different material bonded to the mesh. Either way this results in the flag containing a design on one side while the structure allows the user visibility through the flag.

In some cases it may be optimal in terms of efficiency of creation to utilize a solid object, such as a vinyl or fabric sheet, which contains a design upon it, then creating holes in the object to create the mesh structure required for the utilization as described in this invention. In this case the design can be printed or dyed either before or after the mesh is constructed.

To utilize the flag of the herein described invention, the user(s) is to hold the flag so that the design is viewable by those the user intends to view it. They may hold the flag at any angle. The user(s) should hold the flag close enough that the user(s) may retain some visibility past the flag through the mesh construction.

When utilizing in groups of 2 or more the users are to hold the flag so that the design is viewable by those the users intend to view it. They may hold the flag at any angle. The users should hold the flag close enough that they may retain some visibility past the flag through the mesh construction.

### DESCRIPTION OF THE PREFERRED EMBODIMENT

The Udafan's preferred embodiment would be if it were made up of a mesh fabric that is flexible and dimensions in terms of length and width of 15 feet by 12 feet. The dimensions for the mesh holes would be approximately 3/16″× 3/16″. The fabric if not produced in house usually comes in any amount of yards length, at around 4 feet in width. So for this particular prototype four strips of the following fabric at a length of 15 feet will be used.
Orange—60″ Wide 100% Polyester
˜2.2 Ounces per Square Yard
Mesh openings size is 3/16″× 3/16″.

This Mesh has a slight stretch.

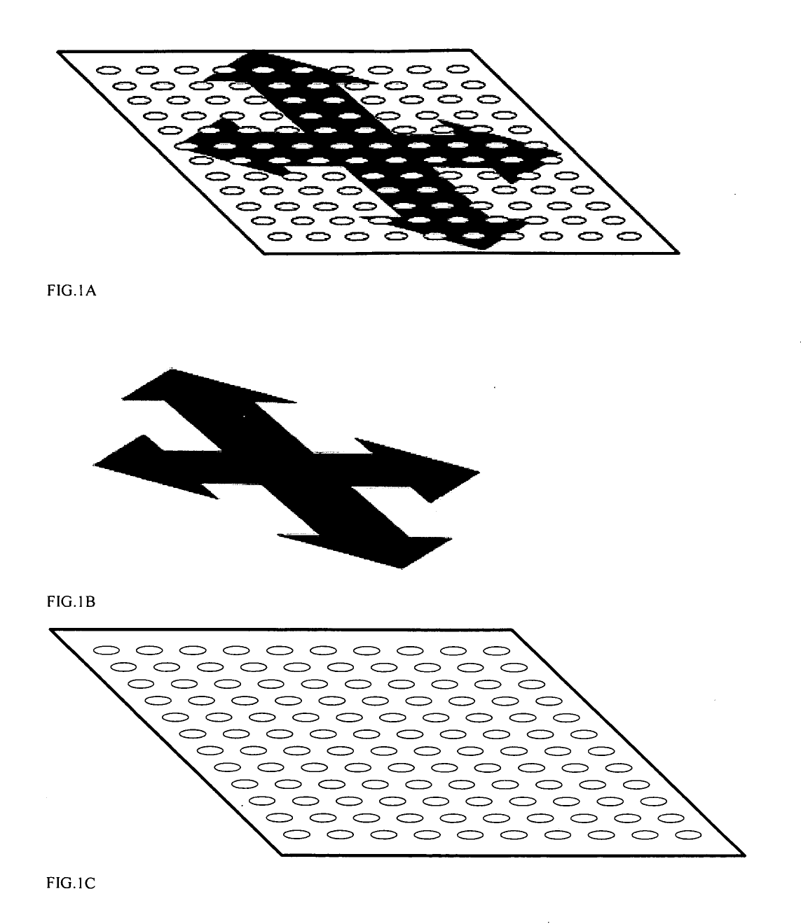

FIG. 3 portrays a close up view of approximately 3″×5″ of the mesh fabric in black and white. The mesh will be joined by sewing or bonding. The joining of the mesh into one unit will result in an object similar to the mesh flag portrayed in FIG. 1C. The reason orange was selected as the color of mesh is because in this case an orange mesh flag is being used as the background color for the image, which is presented in FIG. 1B as a cross with arrows on the ends. The cross will be outlined and whatever is part of the cross will be printed on or dyed black so that the prevalent image is the displayed on the mesh flag. The completed object is an example in FIG. 1A of the invention for which this application is targeting. FIG. 1D portrays a side view of the mesh flag.

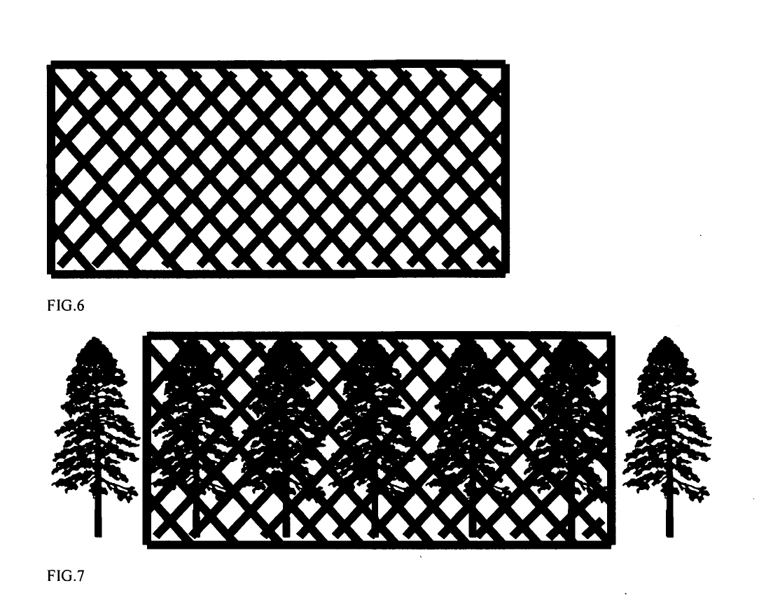

FIG. 5 is a row of trees seen at a distance, which will be used in exemplifying the use of the Udafan Mesh Flag. The row of trees is what the users of the Udafan will be viewing whilst using it. FIG. 6 is the back side of the Udafan Mesh Flag, which for this example does not contain a design upon it, only the front contains the design. When in use, the user(s) would hold up the mesh flag seen in FIG. 5 in front of him or her (them). FIG. 6 shows the use of the Udafan Mesh Flag in use from the perspective of the user(s). The user(s) are able to hold the flag in front of them, for anyone in front to view whatever the image is on the front, while maintaining some level of sight through the flag to the objects, in this case being the row of trees presented in FIG. 5.

The Front surface of the Udafan would portray a symbol, flag, image, or sign of whatever the user wishes. Use of the flag would enable those on the field and in front of the Udafan to see the image while those behind the flag (holding or not) would be able to see through the Udafan and see the playing field or whatever they intend to view. The reason this works is that at close proximity the mesh allows the person to see past the fabric while at a distance, the person cannot see the mesh holes and sees the fabric and therefore the image upon it. This logic is maintained by the example of image 7 above.

1. An enhanced flag wherein the construction is a semi-permeable mesh structure that allows the user(s) at close proximity some level of visibility through the flag.

2. The flag of claim 1, wherein at least one side contains symbols or colors in any design for the purposes of displaying them publicly.

3. The flag of claim 1, intended for the user(s) to hold by hand for portraying to any other group of persons or media for any viewer to which a message (visual) will be communicated.

4. The flag of claim 1, wherein the flag, banner, or article of mesh structure can be of any size mesh, meaning the length, width, and thickness of the holes within the mesh, so long as the fabric is a semi-permeable structure through which a user may have some level of visibility.
